(19) United States
(12) Patent Application Publication
(10) Pub. No.: US 2017/0249661 A1
(43) Pub. Date: Aug. 31, 2017

(54) Generating Actionable Information from Customer-Related Data and Customer Labels

(71) Applicant: International Business Machines Corporation, Armonk, NY (US)

(72) Inventors: Carlos A. Alzate Perez, Dublin (IE); Jean-Baptiste Rémi Fiot, Dublin (IE); Francesco Fusco, Kilcock (IE); Vincent P. A. Lonij, Dublin (IE)

(21) Appl. No.: 15/053,493

(22) Filed: Feb. 25, 2016

(51) Int. Cl. G06Q 30/02; G06N 99/00

(52) U.S. Cl. CPC G06Q 30/0251; G06N 99/005

(57) ABSTRACT

Generating actionable information is provided. A plurality of different types of data corresponding to a set of customers of a service is collected via a network. A list of customers is generated from the set of customers of the service that are likely to take an action corresponding to a business goal. The list of customers is based on a linked set of labels corresponding to the business goal for a subset of customers within the set of customers of the service. The actionable information corresponding to customers within the list of customers is generated. An action step is performed based on the generated actionable information corresponding to the customers within the list of customers.

### BACKGROUND

1. Field

The disclosure relates generally to processing customer-related data and more specifically to generating actionable information from customer-related data and customer labels.

2. Description of the Related Art

Typically, bills, whether phone bills, gas bills, electric bills, or water bills, for example, are read multiple times before they are paid because they contain relevant information, such as amount of usage and balance due. As a result, some electricity and public utility companies insert advertisements into their bills for viewing by all of their customers. However, most of these customers consider the inserted advertisements as irrelevant information because the advertisements do not relate to them.

### SUMMARY

According to one illustrative embodiment, a computer-implemented method for generating actionable information is provided. A computer, via a network, collects a plurality of different types of data corresponding to a set of customers of a service. The computer generates a list of customers from the set of customers of the service that are likely to take an action corresponding to a business goal. The list of customers is based on a linked set of labels corresponding to the business goal for a subset of customers within the set of customers of the service. The computer generates the actionable information corresponding to customers within the list of customers. The computer performs an action step based on the generated actionable information corresponding to the customers within the list of customers. According to other illustrative embodiments, a computer system and computer program product for generating actionable information are provided.

### BRIEF DESCRIPTION OF THE DRAWINGS

FIG. 1 a pictorial representation of a network of data processing systems in which illustrative embodiments may be implemented;

FIG. 2 is a diagram of a data processing system in which illustrative embodiments may be implemented;

FIG. 3 is a diagram illustrating example components of a customer information manager in accordance with an illustrative embodiment;

FIG. 4 is a diagram of an example clustering and labeling process in accordance with an illustrative embodiment;

FIG. 5 is a diagram of an example feature generation process in accordance with an illustrative embodiment;

FIG. 6 is an example of a dataset in accordance with an alternative illustrative embodiment;

FIG. 7 is a diagram illustrating examples of action steps in accordance with an alternative illustrative embodiment; and

FIGS. 8A-8B are a flowchart illustrating a process for generating actionable information in accordance with an illustrative embodiment.

### DETAILED DESCRIPTION

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer readable program instructions.

These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

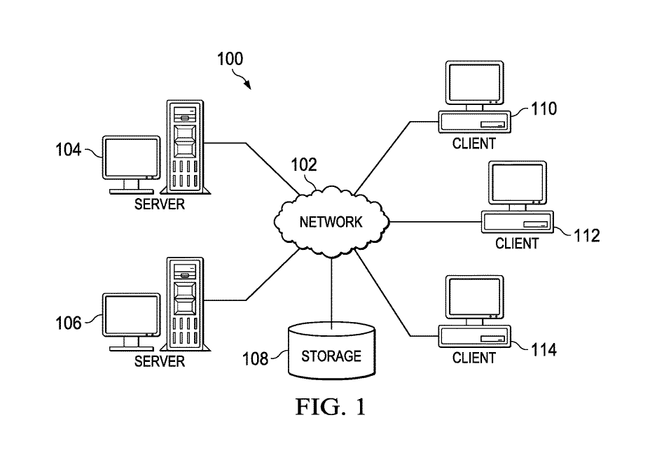

With reference now to the figures, and in particular, with reference to FIGS. 1-3, diagrams of data processing environments are provided in which illustrative embodiments may be implemented. It should be appreciated that FIGS. 1-3 are only meant as examples and are not intended to assert or imply any limitation with regard to the environments in which different embodiments may be implemented. Many modifications to the depicted environments may be made.

FIG. 1 depicts a pictorial representation of a network of data processing systems in which illustrative embodiments may be implemented. Network data processing system 100 is a network of computers, data processing systems, and other devices in which the illustrative embodiments may be implemented. Network data processing system 100 contains network 102, which is the medium used to provide communications links between the computers, data processing systems, and the other devices connected together within network data processing system 100. Network 102 may include connections, such as, for example, wire communication links, wireless communication links, and fiber optic cables.

In the depicted example, server 104 and server 106 connect to network 102, along with storage 108. Server 104 and server 106 may be, for example, server computers with high-speed connections to network 102. In addition, server 104 may provide a service to registered clients. The service may be, for example, a public utility service that provides and monitors usage of a public utility, such as an electric utility, a gas utility, or a water utility. Server 104 may monitor the usage of the public utility via smart meters located at premises of each of the registered clients. A smart meter is an electronic device that measures and records consumption of a public utility in predefined time intervals and communicates this information to a public utility computer, such as server 104, which monitors service usage for billing purposes. The smart meters also may enable two-way communication between the smart meters and server 104.

In addition, server 104 also may provide other services. For example, server 104 may monitor data provided by other types of devices, such as sensors, smart appliances, smart thermostats, smart vehicles, smart phones, and the like. The sensors may be, for example, security sensors, motion sensors, weather sensors, pressure sensors, health monitoring sensors, and the like. The smart appliances may be, for example, smart refrigerators, smart washing machines, smart dish washers, smart coffee makers, and the like. Also, it should be noted that server 104 may represent a plurality of different servers providing a plurality of different services to registered clients.

Further, server 106 also may provide a service to registered clients. For example, server 106 may generate actionable information based on customer-related data, such as smart meter data, and generated customer labels. Actionable information is information upon which server 106 may take a set of one or more action steps, such as, for example, sending targeted advertisements to a selected subset of customers of the service provided by server 104. The set of action steps are linked to a set of one or more business goals associated with the service. Other action steps may include, for example, offering special rates and/or adjusting rates in real time to selected subsets of customers of the service or services provided by server 104. Furthermore, it should be noted that server 106 also may represent a plurality of different servers, which may be located locally or may be distributed remotely within network 102.

Client device 110, client device 112, and client device 114 also connect to network 102. Client devices 110, 112, and 114 are registered clients of server 104 and server 106. Server 104 and server 106 may provide information, such as boot files, operating system images, and software applications to client devices 110, 112, and 114.

In this example, client devices 110, 112, and 114 are illustrated as desktop computers, which may have wire or wireless communication links to network 102. However, it should be noted that client devices 110, 112, and 114 are intended as examples only. In other words, client devices 110, 112, and 114 also may include other devices, such as, for example, smart meters, network computers, laptop computers, handheld computers, smart phones, smart watches, personal digital assistants, gaming devices, sensors, smart appliances, smart thermostats, smart vehicles, or any combination thereof. Server 106 may collect a plurality of different types of data from server 104 and client devices 110, 112, and 114 to generate the actionable information. Moreover, server 106 may link the actionable information to a set of one or more business goals corresponding to the service or services provided by server 104 based on generated labels that are associated with customers of the service or services. It should be noted that the customers are associated with client devices 110, 112, and 114. A business goal for the service may be, for example, to increase service to customers, provide one or more other types of services to customers, sell one or more products associated with a service to customers, and the like.

Storage 108 is a network storage device capable of storing any type of data in a structured format or an unstructured format. In addition, storage 108 may represent a set of one or more network storage devices. Storage 108 may store, for example, names and identification numbers for a plurality of different customers of one or more services, customer profile data, data disclosure parameters, data sharing rules, customer labels, actionable customer information, and action steps. Further, storage 108 may store other data, such as authentication or credential data that may include user names, passwords, and biometric data associated with system administrators, for example.

In addition, it should be noted that network data processing system 100 may include any number of additional server devices, client devices, and other devices not shown. Program code located in network data processing system 100 may be stored on a computer readable storage medium and downloaded to a computer or other data processing device for use. For example, program code may be stored on a computer readable storage medium on server 104 and downloaded to client device 110 over network 102 for use on client device 110.

In the depicted example, network data processing system 100 may be implemented as a number of different types of communication networks, such as, for example, an internet, an intranet, a local area network (LAN), and a wide area network (WAN). FIG. 1 is intended as an example, and not as an architectural limitation for the different illustrative embodiments.

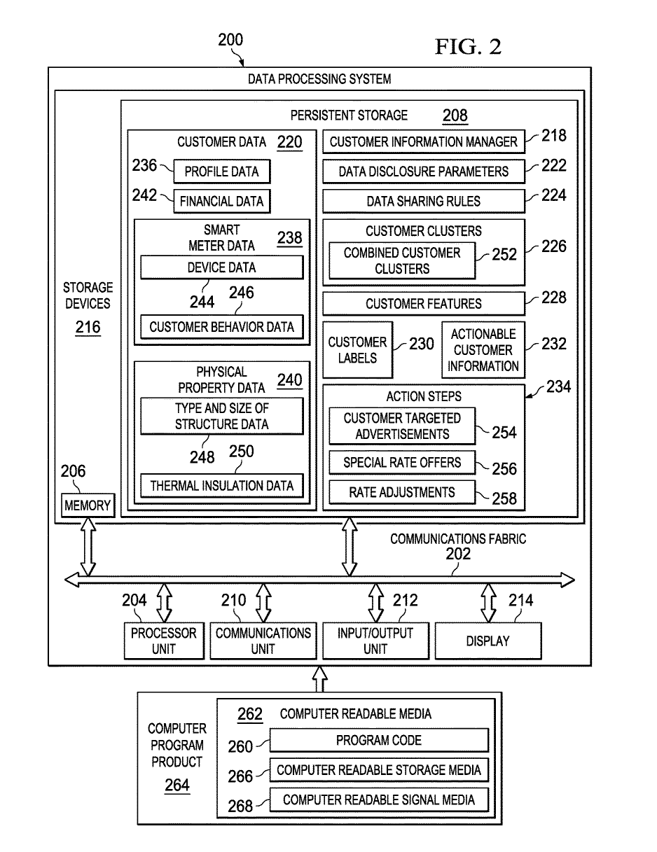

With reference now to FIG. 2, a diagram of a data processing system is depicted in accordance with an illustrative embodiment. Data processing system 200 is an example of a computer, such as server 106 in FIG. 1, in which computer readable program code or program instructions implementing processes of illustrative embodiments may be located. In this illustrative example, data processing system 200 includes communications fabric 202, which provides communications between processor unit 204, memory 206, persistent storage 208, communications unit 210, input/output (I/O) unit 212, and display 214.

Processor unit 204 serves to execute instructions for software applications and programs that may be loaded into memory 206. Processor unit 204 may be a set of one or more hardware processor devices or may be a multi-processor core, depending on the particular implementation. Further, processor unit 204 may be implemented using one or more heterogeneous processor systems, in which a main processor is present with secondary processors on a single chip. As another illustrative example, processor unit 204 may be a symmetric multi-processor system containing multiple processors of the same type.

Memory 206 and persistent storage 208 are examples of storage devices 216. A computer readable storage device is any piece of hardware that is capable of storing information, such as, for example, without limitation, data, computer readable program code in functional form, and/or other suitable information either on a transient basis and/or a persistent basis. Further, a computer readable storage device excludes a propagation medium. Memory 206, in these examples, may be, for example, a random access memory, or any other suitable volatile or non-volatile storage device. Persistent storage 208 may take various forms, depending on the particular implementation. For example, persistent storage 208 may contain one or more devices. For example, persistent storage 208 may be a hard drive, a flash memory, a rewritable optical disk, a rewritable magnetic tape, or some combination of the above. The media used by persistent storage 208 may be removable. For example, a removable hard drive may be used for persistent storage 208.

In this example, persistent storage 208 stores customer information manager 218. Customer information manager 218 collects and controls the customer-related data stored in persistent storage 208 and utilized by data processing system 200. In addition, customer information manager 218 may generate actionable information based on the customer-related data, such as smart meter data, and generated customer labels to achieve one or more predefined business goals associated with a service. It should be noted that even though customer information manager 218 is illustrated as residing in persistent storage 208, in an alternative illustrative embodiment customer information manager 218 may be a separate component of data processing system 200. For example, customer information manager 218 may be a hardware component coupled to communication fabric 202 or a combination of hardware and software components.

Also in this example, persistent storage 208 stores customer data 220, data disclosure parameters 222, data sharing rules 224, customer clusters 226, customer features 228, customer labels 230, actionable customer information 232, and action steps 234. Customer data 220 corresponds to each individual customer in a set of customers of a service. The set of customers of the service may be, for example, all of the customers of the service or a portion of all of the customers. In this example, customer data 220 include profile data 236, smart meter data 238, physical property data 240, and financial data 242. However, it should be noted that illustrative embodiments are not limited to such. In other words, customer data 220 may include more or less information than shown.

Profile data 236 lists information that corresponds to each individual customer. For example, profile data 236 may include information such as name, identification number, address, demographic information, work-related information, hobbies, data disclosure preferences, and the like. The data disclosure preferences may indicate a particular customer's preferences regarding how, how much, and when information corresponding to that particular customer is disclosed.

Smart meter data 238 is information related to a service, such as, for example, a public utility service providing electricity to the customer. Smart meter data 238 indicates the amount of usage of the service by the customer, for example aggregated over one or more periods of time and/or at one or more points in time. Customer information manager 218 may collect smart meter data 238 from a computer associated with the service, such as, for example, server 104 in FIG. 1. In this example, smart meter data 238 also include device data 244 and customer behavior data 246. Device data 244 may indicate, for example, the names and descriptions of different devices connected to the smart meter. Device data 244 also may indicate whether the different types of devices connected to the smart meter are energy efficient devices and/or smart devices. Customer behavior data 246 may indicate, for example, patterns of customer peak usage of the service, such as in early morning and in early evening. These patterns of service usage may indicate work schedule or daily habits of the customer.

Physical property data 240 may include, for example, characteristics of the property where the customer is located. In this example, physical property data 240 include type and size of structure data 248 and thermal insulation data 250. Type and size of structure data 248 may indicate, for example, the type of structure at the customer location, such as a house or warehouse, and the size of the structure. Thermal insulation data 250 may indicate whether the structure at the customer location is thermally insulated and/or the type and amount of thermal insulation. Customer information manager 218 may collect physical property data 240 from the computer associated with the service and/or from public records, for example.

Financial data 242 may include, for example, a billing scheme for a customer, such as electronic billing and automatic payment. Customer information manager 218 may collect financial data 242 from the computer associated with the service and/or from a client device associated with the customer, such as client device 110 in FIG. 1, for example.

Data disclosure parameters 222 may, for example, control a size of a dataset of customer-related information for the set of customers that customer information manager 218 is allowed to disclose in one or more steps of the method. Data disclosure parameters 222 also may control, for example, the data sampling frequency of the smart meter data 238. For example, data disclosure parameters 222 may restrict customer information manager 218 from including information in one or more steps of the method that would personally and publicly identify a customer.

Data sharing rules 224 collectively describe the amount, sampling and type of data that customer information manager 218 may include in the dataset, which may be restricted by federal, state, and/or local regulations. In addition, data sharing rules 224 may describe what type of customer-related data customer information manager 218 may share between different departments or business units within a company or enterprise providing the service. Examples of data sharing rules may include, for example, minimum number of customers per cluster of customers, maximum sampling frequency (f), and maximum ratio (f/n) where (n) is equal to the number of customers.

Customer information manager 218 may adjust data disclosure parameters 222 to ensure compliance with data sharing rules 224. Customer information manager 218 also may provide a user interface to give a human user the possibility to manually adjust data disclosure parameters 222. Customer information manager 218 may optionally indicate whether the new data disclosure parameters are compliant with data sharing rules 224. For example, customer information manager 218 may increase the minimum number of customers per cluster of customers and decrease the maximum sampling frequency to generalize the customer-related data. Customer information manager 218 may adjust customer cluster feature generation parameters to respect data disclosure parameters 222. For example, customer information manager 218 may use the parameter K in a K-means algorithm in order to respect data sharing rules 224 (e.g., the minimum number of customers per cluster of customers). In addition, customer information manager 218 may filter pre-computed customer cluster features. However, customer information manager 218 does not provide complete customer anonymization. For example, customer information manager 218 still needs to link the customer cluster features to the customers or clusters of customers in order to perform one or more action steps regarding the customers, such as sending targeted customer advertisements to a specific subset of all the customers.

Customer clusters 226 represent a plurality of different clusters of customers corresponding to the service. Customer information manager 218 may assign each customer into one or more different clusters of customers based on common characteristics between customers. Customer information manager 218 may utilize, for example, information within customer data 220 to divide the customers into the different clusters. However, it should be noted that customer information manager 218 may utilize any type of clustering process to group the customers of the service into different customer clusters. In this example, customer clusters 226 include combined customer clusters 252. Combined customer clusters 252 represent the combination of two or more of customer clusters 226 into one aggregate customer cluster. Customer information manager 218 may aggregate or combine clusters of customers in customer clusters 226 to achieve a set of predefined business goals corresponding to the service.

Customer features 228 represent a set of one or more features corresponding to each customer of the service or each cluster of customers corresponding to the service. Customer information manager 218 may generate customer features 228 from customer information contained within customer clusters 226 and/or combined customer clusters 252. Customer information manager 218 may utilize a wide collection of machine learning processes to generate customer features 228. For example, customer information manager 218 may utilize a dimensionality reduction process, a dictionary learning process, a projection to orthogonal basis process, which may include, Fourier, wavelets, and the like, a re-sampling process, and/or a clustering process to generate customer features 228. In addition, all of these machine learning processes may contain one or more parameters that may act as data disclosure parameters 222. For example, the parameters may include: 1) a dimension of the generated customer features 228; 2) a number of basis functions, dictionary atoms, or clusters; a re-sampling frequency; or 3) a regularization parameter, such as sparsity, smoothness, and the like.

Customer information manager 218 generates customer labels 230 for all customers from customer feedback received from a limited subset of all of the customers of the service. Customer information manager 218 attaches customer labels 230 to each customer and/or each cluster of customers. Consider a problem where a training dataset {(xi, yi) in X*Y|i=1, . . . , n} is given. Customer information manager 218 builds a function (f) from X to Y. X is typically a vector space of customer features R̂n and Y is typically a discrete space of customer labels, such as, for example, {0, 1, . . . , m}. This problem is supervised machine learning classification. However, in other cases, some customer labels are missing. This problem is semi-supervised machine learning classification. Customer information manager 218 may utilize any number of machine learning processes to solve both of these problems when associating customer labels 230 to customers and/or clusters of customers.

Customer information manager 218 utilizes customer features 228 and customer labels 230 to generate actionable customer information 232. Customer information manager 218 may link actionable customer information 232 to a set of one or more predefined business goals associated with the service. Further, customer information manager 218 may utilize actionable customer information 232 to determine which action step within action steps 234 is appropriate for each individual customer of the service or defined subsets of all of the customers of the service. In this example, action steps 234 include customer targeted advertisements 254, special rate offers 256, and rate adjustments 258. Customer targeted advertisements 254 may represent a plurality of different advertisements that customer information manager 218 directs to particular customers or defined subsets of customers. Special rate offers 256 may represent offerings of special rates for the service that customer information manager 218 sends to particular customers or defined subsets of customers. Rate adjustments 258 may represent customer information manager 218 adjusting service rates in real time or near real time to particular customers or defined subsets of customers.

Communications unit 210, in this example, provides for communication with other computers, data processing systems, and devices via a network, such as network 102 in FIG. 1. Communications unit 210 may provide communications using both physical and wireless communications links. The physical communications link may utilize, for example, a wire, cable, universal serial bus, or any other physical technology to establish a physical communications link for data processing system 200. The wireless communications link may utilize, for example, shortwave, high frequency, ultra high frequency, microwave, wireless fidelity (Wi-Fi), bluetooth technology, global system for mobile communications (GSM), code division multiple access (CDMA), second-generation (2G), third-generation (3G), fourth-generation (4G), 4G Long Term Evolution (LTE), LTE Advanced, or any other wireless communication technology or standard to establish a wireless communications link for data processing system 200.

Input/output unit 212 allows for the input and output of data with other devices that may be connected to data processing system 200. For example, input/output unit 212 may provide a connection for user input through a keypad, a keyboard, a mouse, and/or some other suitable input device. Display 214 provides a mechanism to display information to a user and may include touch screen capabilities to allow the user to make on-screen selections through user interfaces or input data, for example.

Instructions for the operating system, applications, and/or programs may be located in storage devices 216, which are in communication with processor unit 204 through communications fabric 202. In this illustrative example, the instructions are in a functional form on persistent storage 208. These instructions may be loaded into memory 206 for running by processor unit 204. The processes of the different embodiments may be performed by processor unit 204 using computer implemented program instructions, which may be located in a memory, such as memory 206. These program instructions are referred to as program code, computer usable program code, or computer readable program code that may be read and run by a processor in processor unit 204. The program code, in the different embodiments, may be embodied on different physical computer readable storage devices, such as memory 206 or persistent storage 208.

Program code 260 is located in a functional form on computer readable media 262 that is selectively removable and may be loaded onto or transferred to data processing system 200 for running by processor unit 204. Program code 260 and computer readable media 262 form computer program product 264. In one example, computer readable media 262 may be computer readable storage media 266 or computer readable signal media 268. Computer readable storage media 266 may include, for example, an optical or magnetic disc that is inserted or placed into a drive or other device that is part of persistent storage 208 for transfer onto a storage device, such as a hard drive, that is part of persistent storage 208. Computer readable storage media 266 also may take the form of a persistent storage, such as a hard drive, a thumb drive, or a flash memory that is connected to data processing system 200. In some instances, computer readable storage media 266 may not be removable from data processing system 200.

Alternatively, program code 260 may be transferred to data processing system 200 using computer readable signal media 268. Computer readable signal media 268 may be, for example, a propagated data signal containing program code 260. For example, computer readable signal media 268 may be an electro-magnetic signal, an optical signal, and/or any other suitable type of signal. These signals may be transmitted over communication links, such as wireless communication links, an optical fiber cable, a coaxial cable, a wire, and/or any other suitable type of communications link. In other words, the communications link and/or the connection may be physical or wireless in the illustrative examples. The computer readable media also may take the form of non-tangible media, such as communication links or wireless transmissions containing the program code.

In some illustrative embodiments, program code 260 may be downloaded over a network to persistent storage 208 from another device or data processing system through computer readable signal media 268 for use within data processing system 200. For instance, program code stored in a computer readable storage media in a data processing system may be downloaded over a network from the data processing system to data processing system 200. The data processing system providing program code 260 may be a server computer, a client computer, or some other device capable of storing and transmitting program code 260.

The different components illustrated for data processing system 200 are not meant to provide architectural limitations to the manner in which different embodiments may be implemented. The different illustrative embodiments may be implemented in a data processing system including components in addition to, or in place of, those illustrated for data processing system 200. Other components shown in FIG. 2 can be varied from the illustrative examples shown. The different embodiments may be implemented using any hardware device or system capable of executing program code. As one example, data processing system 200 may include organic components integrated with inorganic components and/or may be comprised entirely of organic components excluding a human being. For example, a storage device may be comprised of an organic semiconductor.

As another example, a computer readable storage device in data processing system 200 is any hardware apparatus that may store data. Memory 206, persistent storage 208, and computer readable storage media 266 are examples of physical storage devices in a tangible form.

In another example, a bus system may be used to implement communications fabric 202 and may be comprised of one or more buses, such as a system bus or an input/output bus. Of course, the bus system may be implemented using any suitable type of architecture that provides for a transfer of data between different components or devices attached to the bus system. Additionally, a communications unit may include one or more devices used to transmit and receive data, such as a modem or a network adapter. Further, a memory may be, for example, memory 206 or a cache such as found in an interface and memory controller hub that may be present in communications fabric 202.

In the course of developing illustrative embodiments, it was discovered that sharing smart meter data between different businesses or different departments within a business is difficult. For example, technical constraints may exist, such as large datasets, different data storage systems, et cetera. In addition, bureaucratic constraints may exist, such as getting permission to share smart meter data may be difficult. Further, regulatory constraints may exist that may restrict disclosure of certain customer-related data. For example, energy consumption data may contain sensitive information corresponding to customers.

In the electricity and utility industries, sensitive customer information is included in high-resolution smart meter data. Regulatory restrictions in electricity and utility industries are more stringent than in the Web and telecommunication industries when it comes to distributing and sharing high-resolution, raw data. For example, most Web users agree to have their data used, sold, or consumed as the data are collected in exchange for services the users' want or need, such as Google®, Facebook©, and the like. Electricity and utility regulations require control of and limiting access to the full resolution smart meter time series data. This control may be accomplished by sub-sampling, averaging, adding data noise, dimensionality reduction, and the like. Also, regulatory restrictions may depend on who is receiving the data.

Illustrative embodiments solve the problem of data disclosure by simultaneously: 1) decreasing a size of the customer-related dataset, such as, for example, reducing an amount of detailed smart meter time series data to customer cluster identifiers; and 2) masking defined customer-related sensitive information. For example, instead of sharing smart meter data, such as the presence of individual devices connected to the smart meter or the behaviors of the different customers, illustrative embodiments may only share customer cluster identifiers. In addition, instead of sharing the entire customer-related dataset for open-ended analysis, illustrative embodiments may tune the data disclosure by, for example, adjusting the size of the customer clusters.

Illustrative embodiments combine customer-related smart meter data with collected customer labeling data, such as, for example, customer surveys, customer sales data, customer website navigation activities, and the like, to generate actionable customer information. Illustrative embodiments may link the generated customer labels to business goals associated with a service. Suppose an illustrative embodiment is interested in targeting customers of the service to install new energy efficiency measures, which is a business goal of the service. How the thermal insulation and size of the structure relate to a customer's interest in buying an insulation product is not a-priori clear. For example, not all of the customers that would benefit from installing the energy efficiency measures will be the buyers of the insulation product. Illustrative embodiments generate customer features according to a data disclosure parameter, collect a small subset of customer labels, and provide actionable customer information to achieve the business goal. In other words, illustrative embodiments will predict which customers in the set of all customers will be most likely to purchase the product or list customers from most likely to least likely to purchase the product.

Illustrative embodiments may provide value to customers of the service by sending feedback surveys to only a small subset of customers to provide the customer labeling data. In addition, illustrative embodiments respect customer privacy by not sharing full smart meter data, which illustrative embodiments may tune based on a set of data disclosure parameters.

Illustrative embodiments may provide value to a company, which provides the service, through cost-saving benefits, such as requesting feedback from a small subset of all of the customers of the service to provide the labeling data and generating a limited number of customer labels for the entire set of all customers. This provides value to the company by decreasing network and processing resources. Further, illustrative embodiments may cluster customers with regard to the set of business goals by utilizing cluster boosting, as opposed to “blind” clustering of customers. Furthermore, illustrative embodiments generate actionable customer information based on the limited number of generated customer labels and features derived from the customer clusters. Moreover, illustrative embodiments may continuously update the actionable customer information. Illustrative embodiments also may simultaneously achieve multiple business goals using different sets of customer labels. In addition, illustrative embodiments avoid industrial data management issues, such as, for example, data sharing issues.

In this specification, illustrative embodiments utilize smart meter data provided by electricity smart meters. However, it should be noted that alternative illustrative embodiments may utilize other types of data provided by other types of devices, such as other types of smart meter devices and internet of things devices, which also provide time series data. Examples of other types of devices may include: 1) smart meters that monitor other types of commodities, such as water, gas, and the like; 2) motion sensors; 3) weather sensors that monitor temperature, humidity, and the like; 4) smart appliances, such as refrigerators, washing machines, and the like; 5) smart thermostats; 6) smart vehicles that monitor location, speed, fuel consumption, mileage, engine temperature, and the like; and telecommunication devices, such as smart phones.

Illustrative embodiments are different from methods utilized by the telecommunications industry. For example, the telecommunications industry utilizes call log data to take measurements, such as call duration, which do not represent quantities defined at any particular time. This type of data does not meet the data requirements of illustrative embodiments. As another example, the telecommunications industry utilizes bandwidth aggregated data, which is not time series measured data, such as smart meter data, and does not correlate with human behavior and interaction with household appliances, devices, and equipment. The telecommunications industry analyses the consumption profile using, for example, logs of web requests, protocols, and the like. However, the regulatory data disclose restrictions of the electricity and utility industries are not applicable to the telecommunications industry.

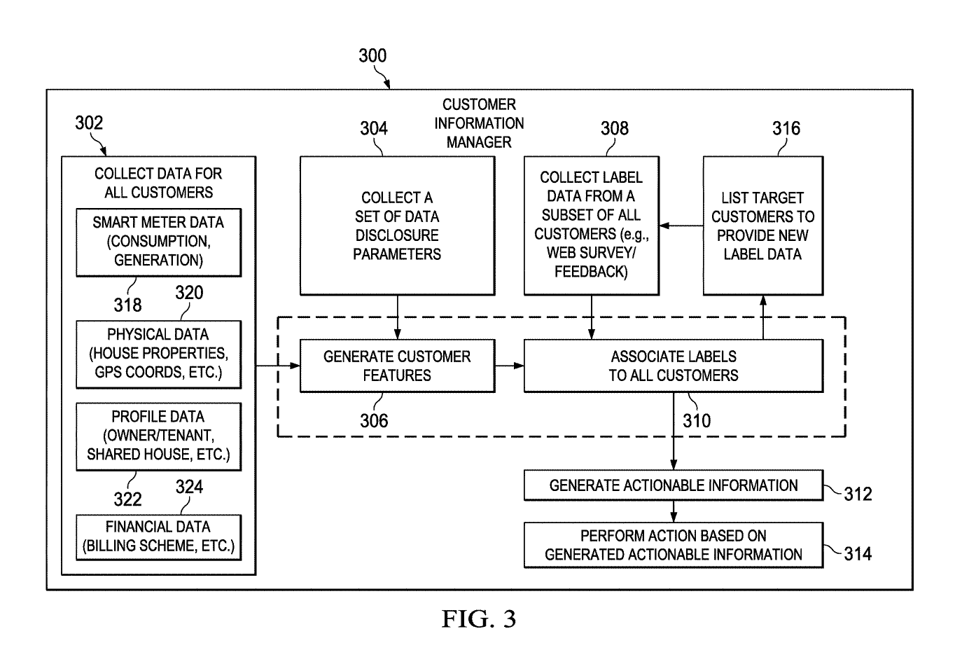

With reference now to FIG. 3, a diagram illustrating example components of a customer information manager is depicted in accordance with an illustrative embodiment. Customer information manager 300 may be implemented in a computer, such as, for example, server 106 in FIG. 1 and data processing system 200 in FIG. 2. Also, customer information manager 300 may be customer information manager 218 in FIG. 2.

Customer information manager 300 generates actionable information based on customer-related data, such as customer data 220 in FIG. 2, and generated customer labels to achieve a set of one or more predefined business goals associated with a service. The service may be, for example, a utility service that provides electricity to customers and monitors usage of the service by the customers via a smart meter. In this example, customer information manager 300 includes components 302, 304, 306, 308, 310, 312, 314, and 316. However, it should be noted that illustrative embodiments are not restricted to such. In other words, illustrative embodiments may include more or fewer components than illustrated. For example, alternative illustrative embodiments may combine two or more components into one component and/or add one or more components not illustrated. In addition, alternative illustrative embodiments may not include component 316, for example. In other words, component 316 may be an optional component.

Customer information manager 300 utilizes component 302 to collect data for all customers of the service. Component 302 may collect via a network, such as network 102 in FIG. 1, the customer-related data corresponding to the service from, for example, one or more computers associated with the service, such as, server 106 in FIG. 1, one or more data processing devices associated with each individual customer, such as client 110 in FIG. 1, and one or more databases containing public records. The collected data may include, for example, smart meter data 318, physical data 320, profile data 322, and financial data 324.

Smart meter data 318 may be, for example, smart meter data 238 in FIG. 2. Smart meter data 318 may include, for example, an amount of energy consumption at each customer location and an amount of energy generation at customer locations. Physical data 320 may be, for example, physical property data 240 in FIG. 2. Physical data 320 may include, for example, house properties, global positioning system coordinates of the house, et cetera. Profile data 322 may be, for example, profile data 236 in FIG. 2. Profile data 322 may include, for example, whether a customer is an owner or tenant of the house, whether the house is a shared house, et cetera. Financial data 324 may be, for example, financial data 242 in FIG. 2. Financial data 324 may include, for example, a billing scheme, et cetera.

Customer information manager 300 performs the following steps: 1) Customer information manager 300 utilizes component 304 to collect a set of data disclosure parameters, such as, for example, data disclosure parameters 222 in FIG. 2; 2) Customer information manager 300 utilizes component 306 to generate customer features, such as, for example, customer clusters 226 in FIG. 2; 3) Customer information manager 300 utilizes component 308 to collect label data via, for example, Web survey feedback, from a subset of all customers of the service; 4) Customer information manager 300 utilizes component 310 to associate labels, such as customer labels 230 in FIG. 2, to all of the customers of the service. It should be noted that steps 1-4 above may each be performed on a different computer system. For example, steps 1 and 2 may be performed on a server, such as server 104 in FIG. 1, and steps 3 and 4 may be performed on a different server, such as server 106 in FIG. 1.

In the case where customer features generated by component 306 are customer clusters, customer information manager 300 may use component 310 to perform cluster boosting with regard to a set of business goals associated with the service. Cluster boosting means that component 310 may take two or more independent sets of cluster labels as input, which may be optionally combined with other customer features, and generate one or more new sets of cluster labels or customer features. This cluster boosting is an important differentiation with existing smart meter analytic methods.

Customer information manager 300 utilizes component 312 to generate actionable information, such as, for example, actionable customer information 232 in FIG. 2. Component 312 generates the actionable information based on the labels associated with the customers. Customer information manager 300 utilizes component 314 to perform an action, such as, for example, an action in action steps 234 in FIG. 2, based on the generated actionable information. Component 314 performs the action to achieve one or more of the set of business goals associated with the service.

Customer information manager 300 utilizes component 316 to list target customers to provide new label data. The list of target customers is a small subset of all of the customers. Component 316 sends the list target customers to component 308 to collect the new label data. Thus, customer information manager 300 may continuously collect new label data to update current customer labels and/or generate new customer labels.

It should be noted that customer information manager 300 may update current customer labels and generate new customer labels without regenerating customer features, which will decrease computation time. In addition, customer information manager 300 may determine which subset of customers is best to acquire the new label data. As a result, customer information manager 300 may limit the number of customers that are contacted for feedback. For example, customer information manager 300 may possibly select the subset of customers for which P(y=1|x, theta) is approximately P(y=—1|x, theta), where y is customer labels in {−1, 1}, x is customer features, theta is the machine learning parameters, and P denotes the probability.

Consequently, customer information manager 300 provides a system to associate a set of one or more labels to each customer or cluster of customers. In the case where the input labels are the answers to survey questions, then the output labels may be, for example, predicted answers for each of the customers, a probability distribution for each answer, or customer clustering related to the answers. Customer information manager 300 may continuously validate and update the output labels by incorporating new observed input labels. Customer information manager 300 also may employ an analytics engine and a process for machine learning.

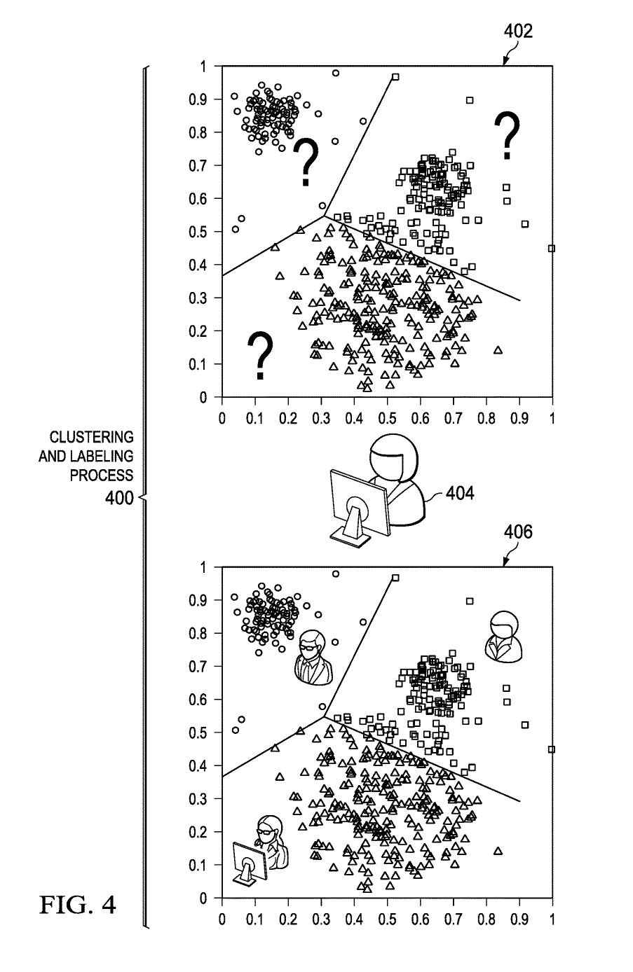

With reference now to FIG. 4, a diagram of an example clustering and labeling process is depicted in accordance with an illustrative embodiment. Clustering and labeling process 400 may be implemented in a customer information manager, such as, for example, customer information manager 300 in FIG. 3. In this example, clustering and labeling process 400 includes step 402, step 404, and step 406. However, it should be noted that illustrative embodiments are not restricted to such. In other words, illustrative embodiments may include more or fewer steps than illustrated. For example, alternative illustrative embodiments may combine two or more steps into one step and/or add one or more steps not illustrated.

Clustering and labeling process 400 utilizes step 402 to identify clusters of similar customers of a service. Step 402 may identify clusters of customers based on smart meter data, such as smart meter data 318 in FIG. 3, for example. In this example, step 402 identifies three different clusters of customers. However, clustering and labeling process 400 wants to assign a meaning to these three different customer clusters.

Clustering and labeling process 400 utilizes step 404 to collect labeling data for a small subset of the consumers of the service using feedback based on, for example, customer answers to Web-based surveys, customer mouse clicks on advertisements within a Website associated with the service, et cetera.

Clustering and labeling process 400 utilizes step 406 to combine the two datasets from steps 402 and 404, which allows step 406 to label the three different clusters of customers, and consequently generate labels for all of the customers of the service. As a result, step 406, using the customer labels, is able to identify actionable customer information for a larger set of customers (e.g., all of the customers of the service). The actionable customer information may be, for example, actionable customer information 232 in FIG. 2. The customer information manager may utilize this actionable customer information to: 1) target specific customers of the service for customer specific advertising; 2) identify specific customers for energy efficiency measures, such as an energy efficient product; and 3) quantify the impact of targeted customers receiving new energy pricing/delivery contracts.

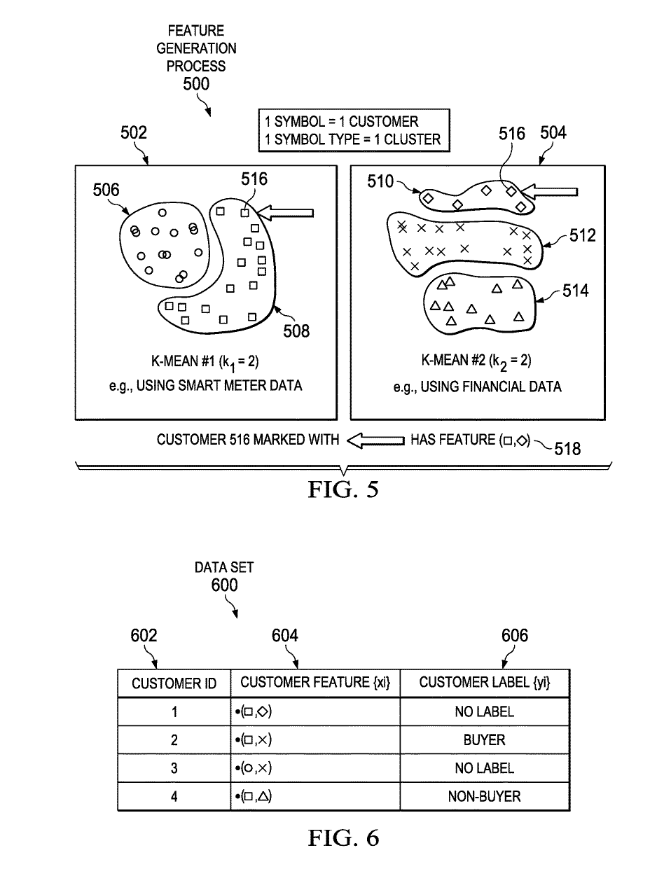

With reference now to FIG. 5, a diagram of an example feature generation process is depicted in accordance with an illustrative embodiment. Feature generation process 500 may be implemented in a customer information manager, such as, for example, customer information manager 300 in FIG. 3. In this example, feature generation process 500 includes k-mean clustering step 502 and k-mean clustering step 504. However, it should be noted that illustrative embodiments are not restricted to such. In other words, illustrative embodiments may include more or fewer k-mean clustering steps than illustrated, or illustrative embodiments may utilize other clustering methods, such as, for example, support vector machines, nearest neighbors, et cetera. In addition, it should be noted in FIG. 5 that one symbol represents one customer and one symbol type represents one cluster of customers in a plurality of different independent sets of customer clusters.

In this example, the customer information manager generates an additional customer feature, to augment customer features 228 in FIG. 2, via 2 k-means (i.e., k-mean #1 in k-mean clustering step 502 and k-mean #2 in k-mean clustering step 504). Each k-mean associates a number in {1, . . . , k} to each customer in the set of customers of a service. Also in this example, k-mean clustering step 502 generates two clusters of customers of the service (i.e., k₁=2) utilizing smart meter data, for example. The two customer clusters are customer cluster 506 and customer cluster 508. Further, k-mean clustering step 504 generates three clusters of customers of the service (i.e., k₂=3) utilizing financial data, for example. The three customer clusters are customer cluster 510, customer cluster 512, and customer cluster 514.

The customer information manager generates for customer 516 marked with [symbol] feature (═,♦) 518. As a result, the customer information manager may generate more accurate labels for all consumers of the service. Also, the customer information manager protects sensitive information in the original smart meter data more or less depending on: 1) the number of customer clusters k₁, which are differentiated by the different dot types, for each k-mean algorithm; 2) the number of k-mean algorithms used; and 3) the choice of sharing or not the centroids of the different clusters of customers.

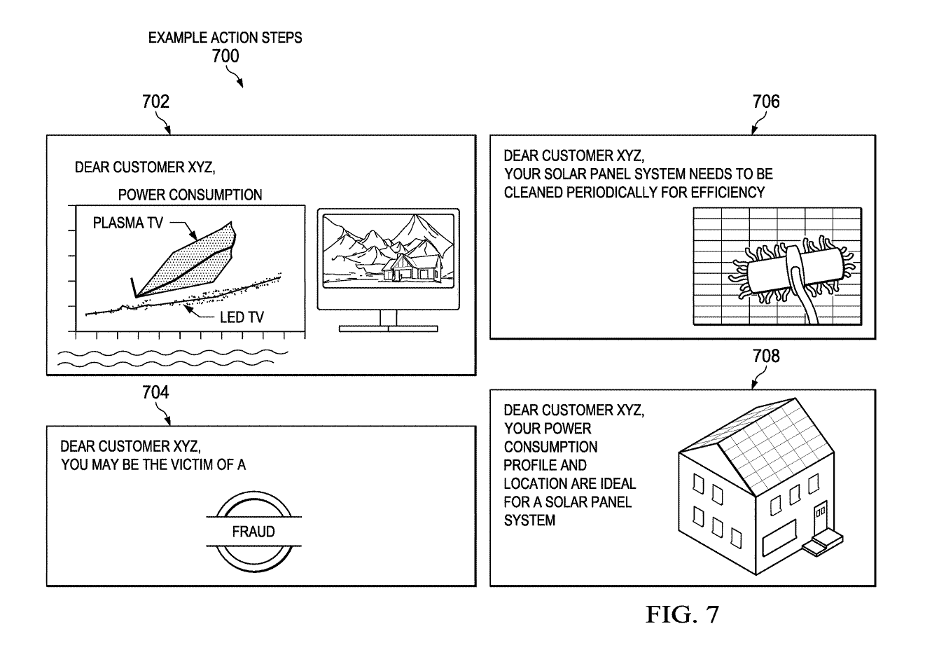

With reference now to FIG. 6, an example of a dataset is depicted in accordance with an alternative illustrative embodiment. Dataset 600 may be implemented in a customer information manager, such as, for example, customer information manager 300 in FIG. 3. In this example, dataset 600 includes customer identification (ID) 602, customer feature 604, and customer label 606. However, it should be noted that illustrative embodiments are not restricted to such. In other words, illustrative embodiments may include more or fewer data in dataset 600 than illustrated.

Customer identification (ID) 602 identifies each particular customer of a service using a corresponding customer number. Customer feature 604 lists a customer feature for each identified customer. Customer feature 604 may be, for example, customer feature 518 in FIG. 5. Customer label 606 lists a label for each identified customer. Customer label 606 may be, for example, a customer label in customer labels 230 in FIG. 2.

In this example, the labels are “buyer” and “non-buyer.” Any supervised, semi-supervised, or other machine-learning-based classifier may associate a label (e.g., “buyer” or “non-buyer”) to customers with “no label.” A typical energy smart meter analytic engine may conclude that a cluster of customers with higher energy bills, for example, is the most relevant customer cluster to sell solar panel system products to. However, this cluster of customers was generated in a blind way with regard to the business goal of selling solar panel systems. Instead, it should be noted that the customer information manager may perform “cluster boosting” based on generated customer labels corresponding to the business goal of selling solar panel systems.

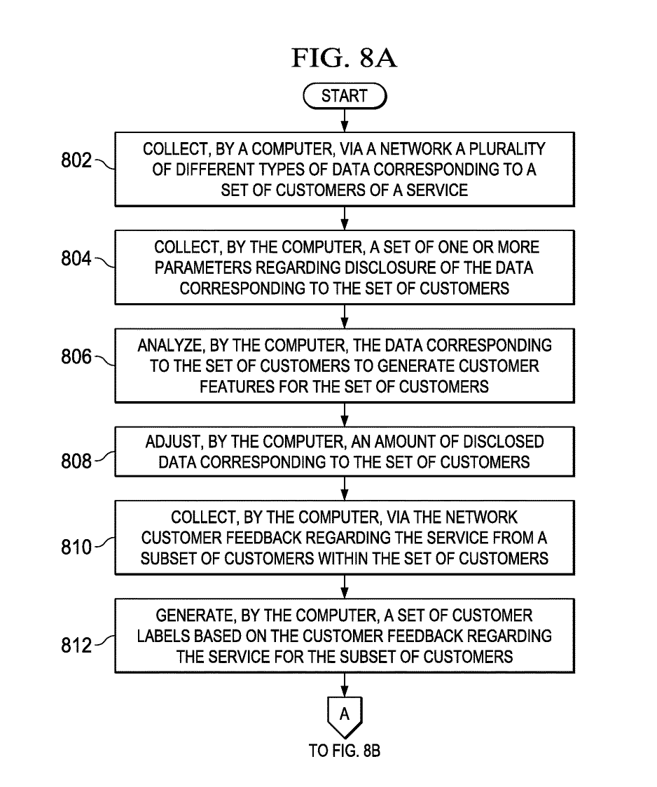

With reference now to FIG. 7, a diagram illustrating examples of action steps is depicted in accordance with an alternative illustrative embodiment. Example action steps 700 may be implemented in a customer information manager, such as, for example, customer information manager 300 in FIG. 3. Example action steps 700 include action step 702, action step 704, action step 706, and action step 708. However, it should be noted that illustrative embodiments are not restricted to such. In other words, illustrative embodiments may include more or fewer action steps than illustrated.

In example action steps 702 and 704, the customer information manager collects labeling data, using component 308 in FIG. 3, for example. The customer information manager collects the labeling data by requesting feedback to a descriptive question, such as, for example, “Does your household use a large plasma TV more than 5 hours a day?” This question is designed for the customer information manager to generate the following actionable customer information, for example: 1) target customers for LED televisions; and 2) fraud detection. As shown in the chart of example action step 702, the power consumption of a plasma television is higher than an LED television.

In example action steps 706 and 708, the customer information manager collects labeling data by requesting feedback to predictive questions, such as, for example, “Have you cleaned your solar panel system recently?” or “Have you bought a solar panel system in the last five years?” These questions are designed for the customer information manager to generate the following actionable customer information, for example: 1) target customers for solar panel system products; 2) target customers for solar panel cleaning services; and 3) identify customers for a different billing plan. As shown in example action step 706, the customer information manager notifies a selected set of customers that a solar panel system needs to be cleaned periodically for efficiency. As shown in example action step 708, the customer information manager notifies another set of selected customers that their power consumption profile and location are ideal for a solar panel system.

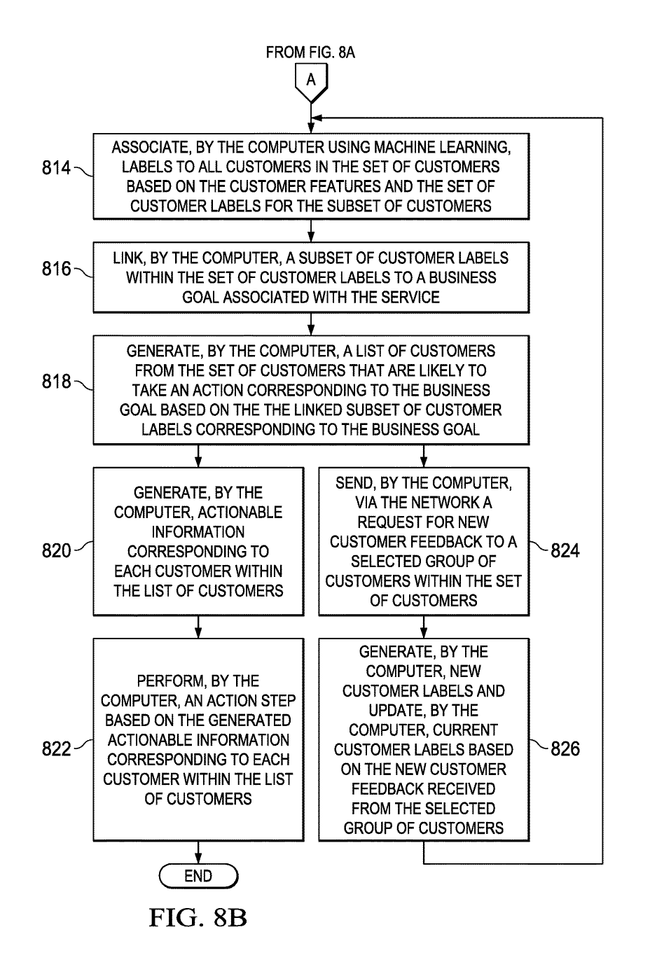

With reference now to FIGS. 8A-8B, a flowchart illustrating a process for generating actionable information is shown in accordance with an illustrative embodiment. The process shown in FIGS. 8A-8B may be implemented in a computer, such as, for example, server 106 in FIG. 1 and data processing system 200 in FIG. 2.

The process begins when the computer collects, via a network, a plurality of different types of data corresponding to a set of customers of a service (step 802). The plurality of different types of data corresponding to the set of customers of the service may be, for example, customer data 220 in FIG. 2. In addition, the computer collects a set of one or more parameters regarding disclosure of the data corresponding to the set of customers (step 804). The set of parameters regarding disclosure of the data may be, for example, data disclosure parameters 222 in FIG. 2.

Further, the computer analyzes the data corresponding to the set of customers to generate customer features for the set of customers (step 806). The customer features may be, for example, customer clusters 226 in FIG. 2. Afterward, the computer adjusts an amount of disclosed data corresponding to the set of customers (step 808). In one embodiment, this adjustment may be achieved by removing regulated sensitive data based on the set of one or more parameters regarding the disclosure of the data corresponding to the set of customers. In another embodiment, the generation of customer features in step 806 may be configured so that the generated customer features do not contain any sensitive information. The computer also collects, via the network, customer feedback regarding the service from a subset of customers within the set of customers (step 810). Then, the computer generates a set of customer labels based on the customer feedback regarding the service for the same subset of customers (step 812).

Then, the computer, using machine learning, associates labels to all customers in the set of customers based on the customer features and the set of customer labels for the subset of customers (step 814). In the process of associating customer labels, if the customer features include cluster labels, then step 814 may include “cluster boosting” (i.e., multiple independent sets of cluster labels may be combined). In addition, the computer links a subset of customer labels within the set of customer labels to a business goal associated with the service (step 816). Further, the computer generates a list of customers from the set of customers that are likely to take an action corresponding to the business goal based on the linked subset of customer labels corresponding to the business goal (step 818).

Subsequently, the computer generates actionable information corresponding to each customer within the list of customers (step 820). The computer performs an action step based on the generated actionable information corresponding to each customer within the list of customers (step 822).

In parallel with step 820, the computer sends, via the network, a request for new customer feedback to a selected group of customers within the set of customers (step 824). The computer then generates new customer labels and updates current customer labels based on the new customer feedback received from the selected group of customers (step 826). Thereafter, the process returns to step 814 where the computer associates updated customer labels to all customers. It should be noted that steps 824 and 826 are optional steps. In other words, the computer may not perform steps 824 and 826. As a result, the process may terminate after step 822.

Thus, illustrative embodiments of the present invention provide a computer-implemented method, computer system, and computer program product for generating actionable information from customer-related smart meter data and customer labels. The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiment. The terminology used herein was chosen to best explain the principles of the embodiment, the practical application or technical improvement over technologies found in the marketplace, or to enable others of ordinary skill in the art to understand the embodiments disclosed here.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

What is claimed is:

1. A computer-implemented method for generating actionable information, the computer-implemented method comprising:
collecting, by a computer, via a network, a plurality of different types of data corresponding to a set of customers of a service;
generating, by the computer, a list of customers from the set of customers of the service that are likely to take an action corresponding to a business goal, wherein the list of customers is based on a linked set of labels corresponding to the business goal for a subset of customers within the set of customers of the service;
generating, by the computer, the actionable information corresponding to customers within the list of customers; and
performing, by the computer, an action step based on the generated actionable information corresponding to the customers within the list of customers.

2. The computer-implemented method of claim 1 further comprising:
receiving, by the computer, via the network, customer features for the set of customers from a server that generated the customer features; and
combining, by the computer, one or more customer features.

3. The computer-implemented method of claim 2 further comprising:
collecting, by the computer, a set of one or more parameters regarding disclosure of the data corresponding to the set of customers.

4. The computer-implemented method of claim 3 further comprising:
adjusting, by the computer, a nature and a quantity of disclosed data transferred between the server and the computer using the set of one or more parameters regarding the disclosure of the data corresponding to the set of customers.

5. The computer-implemented method of claim 3 further comprising:
adjusting, by the computer, an amount of disclosed data corresponding to the set of customers by removing sensitive data based on the set of one or more parameters regarding the disclosure of the data corresponding to the set of customers.

6. The computer-implemented method of claim 3 further comprising:
collecting, by the computer, via the network, customer feedback regarding the service from a subset of customers within the set of customers; and
generating, by the computer, a set of customer labels based on the customer feedback regarding the service.

7. The computer-implemented method of claim 6 further comprising:
associating, by the computer, using machine learning, labels to all customers in the set of customers based on the customer features and the set of customer labels for the subset of customers.

8. The computer-implemented method of claim 6 further comprising:
linking, by the computer, a subset of customer labels within the set of customer labels corresponding to the business goal.

9. The computer-implemented method of claim 1 further comprising:
sending, by the computer, via the network, a request for new customer feedback to a selected group of customers within the set of customers, wherein the computer selects the selected group of customers using an output of a machine learning process to limit a number of customers selected in the selected group of customers; and
generating, by the computer, new customer labels and updating current customer labels based on the new customer feedback received from the selected group of customers.

10. The computer-implemented method of claim 1 further comprising:
generating, by the computer, targeted actionable information corresponding to a specific subset of customers within the list of customers; and
performing, by the computer, an action step based on the targeted actionable information corresponding to the specific subset of customers within the list of customers.

11. A computer system for generating actionable information, the computer system comprising:
a bus system;
a storage device connected to the bus system, wherein the storage device stores program instructions; and
a processor connected to the bus system, wherein the processor executes the program instructions to:
collect, via a network, a plurality of different types of data corresponding to a set of customers of a service;
generate a list of customers from the set of customers of the service that are likely to take an action corresponding to a business goal, wherein the list of customers is based on a linked set of labels corresponding to the business goal for a subset of customers within the set of customers of the service;
generate the actionable information corresponding to customers within the list of customers; and
perform an action step based on the generated actionable information corresponding to the customers within the list of customers.

12. The computer system of claim 11, wherein the processor further executes the program instructions to:
receive, via the network, customer features for the set of customers from a server that generated the customer features; and
combine one or more customer features.

13. The computer system of claim 12, wherein the processor further executes the program instructions to:
collect a set of one or more parameters regarding disclosure of the data corresponding to the set of customers.

14. A computer program product for generating actionable information, the computer program product comprising a computer readable storage medium having program instructions embodied therewith, the program instructions executable by a computer to cause the computer to perform a method comprising:
collecting, by the computer, via a network, a plurality of different types of data corresponding to a set of customers of a service;
generating, by the computer, a list of customers from the set of customers of the service that are likely to take an action corresponding to a business goal, wherein the list of customers is based on a linked set of labels corresponding to the business goal for a subset of customers within the set of customers of the service;
generating, by the computer, the actionable information corresponding to customers within the list of customers; and
performing, by the computer, an action step based on the generated actionable information corresponding to the customers within the list of customers.

15. The computer program product of claim 14 further comprising:
receiving, by the computer, via the network, customer features for the set of customers from a server that generated the customer features; and
combining, by the computer, one or more customer features.

16. The computer program product of claim 15 further comprising:
collecting, by the computer, a set of one or more parameters regarding disclosure of the data corresponding to the set of customers.

17. The computer program product of claim 16 further comprising:
adjusting, by the computer, a nature and a quantity of disclosed data transferred between the server and the computer using the set of one or more parameters regarding the disclosure of the data corresponding to the set of customers.

18. The computer program product of claim 16 further comprising:
adjusting, by the computer, an amount of disclosed data corresponding to the set of customers by removing sensitive data based on the set of one or more parameters regarding the disclosure of the data corresponding to the set of customers.

19. The computer program product of claim 16 further comprising:
collecting, by the computer, via the network, customer feedback regarding the service from a subset of customers within the set of customers; and
generating, by the computer, a set of customer labels based on the customer feedback regarding the service.

20. The computer program product of claim 14 further comprising:
sending, by the computer, via the network, a request for new customer feedback to a selected group of customers within the set of customers, wherein the computer selects the selected group of customers using an output of a machine learning process to limit a number of customers selected in the selected group of customers; and
generating, by the computer, new customer labels and updating current customer labels based on the new customer feedback received from the selected group of customers.
